(19) United States
(12) Patent Application Publication
(10) Pub. No.: US 2012/0109611 A1
(43) Pub. Date: May 3, 2012

(54) System and Method for Performing Wellsite Containment Operations

(76) Inventors: Matteo Loizzo, Berlin (DE); Brice Lecampion, Cambridge, MA (US); Laure Deremble, Mountrouge (FR); Bruno Huet, Lyon (FR)

(21) Appl. No.: 13/319,731

(22) PCT Filed: May 12, 2010
(86) PCT No.: PCT/IB10/01235

§ 371 Date: Jan. 16, 2012

Related U.S. Application Data
(60) Provisional application No. 61/177,661, filed on May 13, 2009.

(51) Int. Cl. G06G 7/48

(52) U.S. Cl. 703/10

(57) ABSTRACT

A system and method for performing an adaptive wellsite operation about a wellsite having a sub-surface system with a wellbore formed through at least one subterranean formation, wherein the subterranean formations are configured to store fluid. The system has a containment unit. The containment unit has a static model unit for generating a static model of a subsurface system. The static model unit further has a defect model unit for generating a defect model. The containment unit has a dynamic leak model unit for generating a dynamic leak model. The containment unit has a leak mitigation unit for providing at least one containment plan. The leak mitigation unit and the dynamic leak model unit are integrated for passing data therebetween and whereby the containment plan may be adapted as the static model, the defect model, and/or the dynamic model is generated.

### CROSS-REFERENCE TO RELATED APPLICATION

This application claims the priority benefit of U.S. Provisional Patent Application No. 61/177,661, filed by Applicant on May 13, 2009, the entire contents of which is hereby incorporated by reference.

### BACKGROUND

The present invention relates to techniques for performing oilfield operations relating to subterranean formations having reservoirs therein. More particularly, the present invention relates to techniques for performing containment operations (e.g., determining, evaluating, and minimizing the risk of leaks of subterranean fluids) about a wellbore.

Oilfield operations are typically performed to locate and gather valuable downhole fluids. Typical oilfield operations may include, for example, surveying, drilling, wireline testing, completions, production, planning, oilfield analysis, fluid injection, fluid storage and abandonment. One such operation is the injecting fluids, such as carbon dioxide (CO2), downhole for storage at subsurface locations. Key to the drilling operation is preventing leaks of such injected fluids.

Before drilling begins, a field development plan (FDP) may be prepared to define how the drilling operation will be performed. Data concerning a proposed field is considered, and the FDP designed to meet certain objectives for the field, such as reaching optimal reservoir locations. The FDP may include various operational specifications for performing drilling and other oilfield operations. For example, drilling specifications may specify items, such as platform locations, well or borehole trajectories, wellbore capacity, completion type, location, equipment, and/or flow rate.

During the drilling operation subterranean formations and reservoirs may be hydraulically isolated. Fluids may be injected into the subterranean formations and/or reservoirs for storage and to perform oilfield operations. Typical fluids that may be injected into the wellbore may be, for example, water, acid gas, cement, drilling mud, CO2 and the like (“injected fluids”). The hydraulic isolation of the subterranean formations and/or reservoirs may be necessary for successful oilfield operations.

A number of sealing techniques using sealing components such as using flowable or swellable materials may be used to seal the well-bore across the subterranean formations or a steel casing in the wellbore. Varying sealing techniques may be used over the length of the wellbore. A common technique involves cementing over a large depth of the annulus between the subterranean formation and the steel casing or between two steel casings. Packers and cement plugs are also routinely used as sealing material within the center part of the well-bore.

Unwanted leaks through the sealing components of the wellbore may cause undesirable effects, such as revenue losses or damage to health, safety and the environment. When CO2 or other waste products are injected into a wellbore for geological storage there is a need to eliminate and minimize leakage. Preventing and remediating leakages in new or existing wells typically requires a refined understanding of the leakage pathways (position and dimensions) and their evolution through time. The current capacity to predict the occurrence of leaks, the size of leaks and the ability to remediate the leaks is limited. Attempts to remediate leaks may involve, for example, blind cement squeezes into the wellbore. Many leaks may be detected only when damage to resources or population is already significant, and their remediation requires extensive, uncertain well intervention and possibly abandonment.

While sealing techniques may provide a temporary seal in the wellbore leaks may still occur during the life of the wellbore and/or during the storage of waste products. Attempts have been made that relate to downhole storage and/or leaks as described, for example, in Patent/Application Nos. PCT/FR2007/000317, U.S. Pat. No. 6,344,789, U.S. Pat. No. 6,687,738, U.S. Pat. No. 7,133,778, US2001/0017209, US20030163257, US2008/0271891, US2008/0319726, US2009/0151559, US2010/0000737 and US 2010/0082375

Despite the existence of techniques relating to downhole storage and leaks, there remains a need to design drilling operations and leak mitigation based on a better understanding of wellsite conditions. It is desirable that such techniques take into consideration the conditions of the subterranean formations. It is further desirable that such techniques take action in response to such conditions to avoid certain leakage. Such techniques are preferably capable of one or more of the following, among others: detecting defects in a subsurface system; detecting leaks in a subsurface system; detecting leak matrixes in a subsurface system; predicting the leak paths of the leaks in the subsurface system; predicting the evolution of the defects, the leaks, and the leak matrixes as they react with downhole fluids; providing real time updates; developing a plan to minimize the occurrences of leaks from the subterranean formations and/or the wellbore.

### SUMMARY

The present invention relates to a containment unit for performing leak mitigation operations about a wellsite. The containment unit has a transceiver operatively connected to a controller at the wellsite for communication therewith. The containment unit has a static model unit for generating a static model of a subsurface system. The static model unit comprises a defect model unit for generating a defect model wherein the defect model has a combination of known defects and/or probable defects of the subterranean formation and installed wellsite equipment. The containment unit further has a dynamic leak model unit for generating a dynamic leak model, wherein the dynamic leak model is for predicting a leak evolution of at least one known and/or probable leak. The containment unit has a leak mitigation unit for providing at least one containment plan for minimizing the at least one leak in the wellsite, and wherein the leak mitigation unit and the dynamic leak model unit are integrated for passing data therebetween and whereby the containment plan may be adapted as the static model, the defect model, and/or the dynamic model is generated.

The static model unit of the containment unit has a subterranean formation unit for generating a subterranean formation model that characterizes at least one property of at least one subterranean formation.

The static model unit of the containment unit has a wellbore model unit for generating an installed wellbore model that characterizes at least one property of at least a portion of installed downhole equipment.

The wellbore model unit of the containment unit characterizes at least one property of the wellbore and subterranean formation contact zone.

The static model unit of the containment unit has a leak prediction model unit for generating a leak prediction model based on the defect model, wherein the leak prediction model determines the at least one probable leak in the wellsite.

The present invention relates to a system performing a containment operation about a wellsite. The system has an injection system configured to inject fluid into the wellbore for storage within a subterranean formation and at least one seal configured to prevent the injected fluid from escaping from the wellbore. The system has a containment unit. The containment unit has a transceiver operatively connected to a controller at the wellsite for communication therewith and a static model unit for generating a static model of a subsurface system. The static model unit has a defect model unit for generating a defect model wherein the defect model has a combination of known defects and/or probable defects of the subterranean formation and installed wellsite equipment. The containment unit has a dynamic leak model unit for generating a dynamic leak model, wherein the dynamic leak model is for predicting a leak evolution of at least one known and/or probable leak. The containment unit has a leak mitigation unit for providing at least one containment plan for minimizing the at least one leak in the wellsite and wherein the leak mitigation unit and the dynamic leak model unit are integrated for passing data therebetween and whereby the containment plan may be adapted as the static model, the defect model, and/or the dynamic model is generated. The system has at least one monitoring tool for collecting data about the wellsite.

The injected fluid of the system may be a carbon dioxide.

The static model of the system has a subterranean formation unit for generating a subterranean formation model that characterizes at least one property of at least one subterranean formation.

The static model of the system has a wellbore model unit for generating an installed wellbore model that characterizes at least one property at least a portion of installed downhole equipment.

The wellbore model unit of the system characterizes at least one property of the wellbore and subterranean formation contact zone.

The static model unit of the system has a leak prediction model unit for generating a leak prediction model based on the defect model, wherein the leak prediction model determines the at least one probable leak in the wellsite.

The present invention relates to a method for performing a containment operation about a wellsite having a subsurface system having a wellbore formed through at least one subterranean formations wherein the subterranean formations are configured to store fluids. The method involves collecting initial data from the wellsite and providing a containment unit. The containment unit has a transceiver operatively connected to a controller at the wellsite for communication therewith and a static model unit for generating a static model of a subsurface system. The static model unit has a defect model unit for generating a defect model wherein the defect model has a combination of known defects and/or probable defects of the subterranean formation and installed wellsite equipment. The containment unit has a dynamic leak model unit for generating a dynamic leak model, wherein the dynamic leak model is for predicting a leak evolution of at least one known and/or probable leak. The containment unit has a leak mitigation unit for providing at least one containment plan for minimizing the at least one known and/or probable leak in the wellsite and wherein the leak mitigation unit and the dynamic leak model unit are integrated for passing data therebetween and whereby the containment plan may be adapted as the static model, the defect model, and/or the dynamic model is generated. The method further involves constructing the static model of the subsurface system and constructing the dynamic leak model of the subsurface system. The method further involves developing a containment plan.

The method comprises collecting supplemental data from the wellsite during wellbore operations by monitoring subsurface conditions at the wellsite.

The method comprises updating the dynamic model from supplemental data thereby constructing a new dynamic model.

The method comprises executing the containment plan.

### BRIEF DESCRIPTION OF THE DRAWINGS

The present embodiments may be better understood, and numerous objects, features, and advantages made apparent to those skilled in the art by referencing the accompanying drawings. These drawings are used to illustrate only typical embodiments of this invention, and are not to be considered limiting of its scope, for the invention may admit to other equally effective embodiments. The figures are not necessarily to scale and certain features and certain views of the figures may be shown exaggerated in scale or in schematic in the interest of clarity and conciseness.

FIG. 1 is a schematic diagram depicting a system for performing a wellsite containment operation, the system having a drilling tool suspended from a rig and advanced into a subterranean formation, and a containment unit.

FIG. 2 is a schematic diagram depicting the system of FIG. 1 with the drilling tool removed and the wellbore completed with a monitoring tool deployed therein.

FIG. 3 is a schematic diagram depicting the system of FIG. 2 with the rig removed and provided with a fluid injection system for injecting fluids into the wellbore.

FIG. 4A is a schematic diagram depicting the system of FIG. 3 provided with a downhole sealing system.

FIGS. 4B-4E are detailed views of portions 4B and 4D of the wellbore of FIG. 4A.

FIG. 5A is a schematic view of one or more containment systems in the wellbore of FIG. 4A.

FIG. 5B is a detailed view of a portion 5B of the wellbore of FIG. 5A depicting one or more leak paths.

FIG. 6 is a schematic view of the containment unit of FIG. 1.

FIG. 7 is a flow diagram illustrating a method for performing a containment operation.

### DESCRIPTION OF EMBODIMENT(S)

The description that follows includes exemplary apparatus, methods, techniques, and instruction sequences that embody techniques of the present inventive subject matter. However, it is understood that the described embodiments may be practiced without these specific details.

During the life of a wellsite, systems within the wellsite may develop defects and leaks. The defects and leaks may be developed in one or more subterranean formations, a wellbore, downhole equipment installed in the wellbore, sealing components, and/or in sealing systems within the wellbore. The fluid moving through the leak may be naturally occurring subterranean fluids, or any number of injected fluids. A leak may be defined between a pressure source and a target, such as an intermediate permeable formation (aquifers, intermediate reservoirs) or the Earth's surface, as will be discussed in more detail below. A containment (or leak mitigation) plan may be developed and executed in order to mitigate and/or prevent the risk of leaks escaping from the wellsite.

The containment plan may be developed prior to wellsite operations, during drilling operations, during completions of the wellsite, during fluid injection operations, and/or after the fluid injection operations. The containment plan may be developed by collecting all suitable and/or available data from the wellsite, developing a static model of the wellsite, developing a dynamic model of the wellsite, developing a historical data base to update the dynamic and static models, and creating and executing a containment procedure. The execution of the containment plan is discussed below at each phase of the wellsite operations.

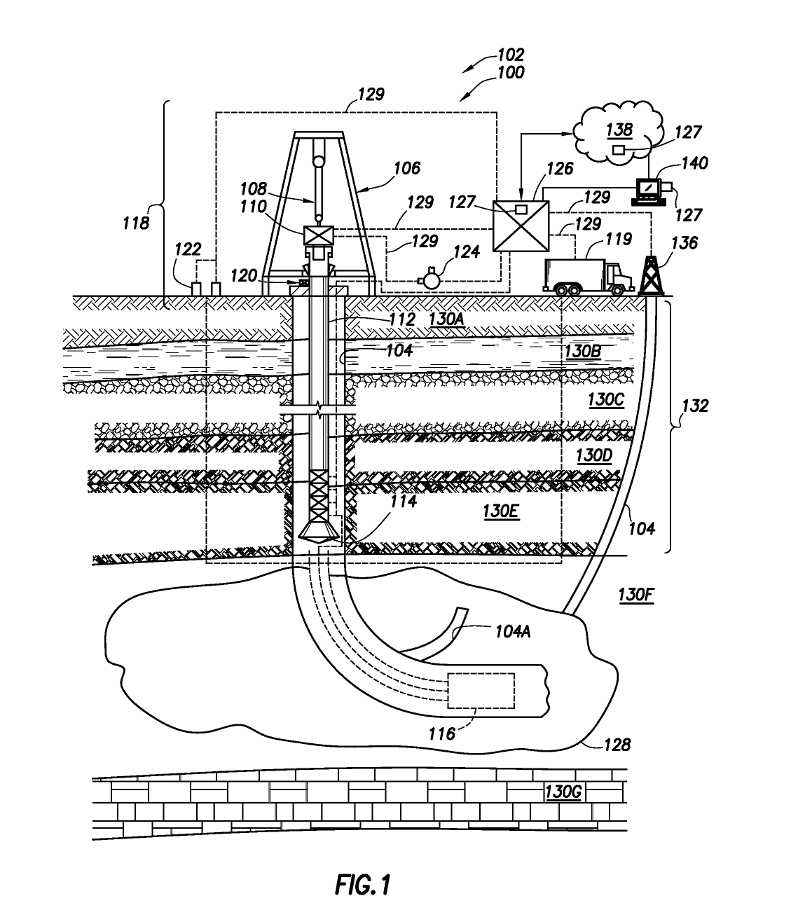

FIG. 1 depicts a schematic view of a wellsite 100 including a system 102 for developing and executing a containment plan before, during and after performing wellsite operations. As shown, the wellsite 100 is a land based wellsite, but could also be water based. The wellsite 100 may have any number of wellbores 104 and/or wellbore sidetracks 104A. The wellsite 100 may have a number of associated wellsite equipment, such as drilling tools, logging tools, sensors, production tools, and monitors such as a drilling rig 106, a hoisting device 108, a rotation inducing tool 110, a conveyance 112, a drill bit 114, at least one downhole monitoring tool 116, at least one surface monitoring tool (such as a seismic wave inducing tool 119, a pressure sensor 120, and at least one receiver 122), a fluid pumping system 124, and a controller 126. The controller 126 may have a containment unit 127 for developing and executing the containment plan.

The wellsite 100 may be configured to produce and/or store hydrocarbons, or other valuable fluids, from or in one or more reservoirs 128 located in a rock formation 130(A-G) beneath the Earth's surface. Between the Earth's surface and the reservoir 128 there may be any number of non-producing rock formations 130A-E, know as an overburden 132. As shown, there are several rock formations 130A-130G, or subterranean formations. Below the reservoir 128 there may be the subterranean formation 130G of bedrock. The reservoir 128 as shown is located in the subterranean formation 130F. The subterranean formation 130E above the reservoir 128 may be a cap rock. Above the cap rock there may be any number of subterranean formations 130D that include varying cap rocks, aquifers, and permeable formations. The subterranean formations 130A-G may be any of the subterranean formations described herein as well as soil, silt, earth, clay and/or mud formations.

The drilling rig 106 may be configured to advance the drill bit 114 into the earth in order to form the wellbore 104. The hoisting device 108 may lift segments of the conveyance 112 in order to couple the segments into a string. The rotating drill bit 114 forms the wellbore 104 as the conveyance 112 is advanced in the wellbore 104. The conveyance 112 may be any suitable conveyance for forming the wellbore 104 including, but not limited to, a drill string, a casing string, coiled tubing, and the like. The fluid pumping system 124 may be a pump for pumping drilling mud into the conveyance 112 to lubricate the drill bit, control formation pressure, and rotate the drill bit 114. The fluid pumping system 124 may further be used for the subterranean formation(s) 130 (A-G) stimulation treatments, and/or reservoir 128 stimulation treatments. The fluid pumping system 124 may further be used to pump cement into the wellbore 104. The fluid pumping system 124 may also be used as a part of a fluid injection system for injecting fluids for storage into the wellbore 104. Although one fluid pumping system 124 is shown, there may be several different fluid pumping systems for performing wellsite operations.

Additional downhole tools, devices and systems for drilling operations, completions operation and production operations may be used at the wellsite 100, such as drill bit steering tools, whipstocks, packers, downhole pumps, valves, and the like.

The controller 126 may send and receive data to and from any of the tools, devices and systems associated with the wellsite 100. The system 102 may include a network 138 for communicating between the well-site 100 components, systems, devices and tools. Further, the network 138 may communicate with one or more offsite communication devices 140, such as computers, personal digital assistants, and the like. The network 138 and/or the controller 126 may communicate with any of the tools, devices and systems using any combination of communication links 129 and/or communication devices such as wired, telemetry, wireless, fiber optics, acoustic, infrared, a local area network (LAN), a personal area network (PAN), and/or a wide area network (WAN) and the like. The connection may be made via the network 138 to an external computer (for example, through the Internet using an Internet Service Provider) and the like.

The containment unit 127 may be located within the controller 126. Further, there may be multiple containment units 127 located about the wellsite 100, for example within the network 138 and/or the one or more offsite communication devices 140. As shown, the whole containment unit 127 is located within the controller 126, however, it should be appreciated that portions of the containment unit 127 may be split up about the wellsite 100.

The containment plan may be initially developed by collecting data in the containment unit 127. The collected data may comprise data collected prior to wellsite operations, prior to drilling, during drilling, during cementing, during completions, during stimulation operations, during injection operations, during sealing operations, during storage, after the wellbore has been abandoned and/or before, during and/or after any wellsite operations. Prior to wellsite operations, subterranean formation data may be collected from other wells in the area, operator knowledge of the area, area seismic data, area geological data, and the like. Wellsite operations commence data may be collected by the downhole monitoring tools 116, the surface monitoring tools 118, operator knowledge and the like. The data may comprise, for example, subterranean formation data and/or wellbore data. The subterranean formation data and/or wellbore data may relate to the condition of the subterranean formation(s), the wellbore, and/or installed downhole equipment.

Subterranean formation data may be static or dynamic data. Static data may relate to, for example, formation structure and geological stratigraphy that defines the geological structure of the subterranean formation. Dynamic data may relate to, for example, fluids flowing through the geologic structures of the subterranean formation over time. Such static and/or dynamic data may be collected to learn more about the formations and the valuable assets contained therein.

The downhole monitoring tools 116 and surface monitoring tools 118 may include any device capable of detecting, determining, and/or predicting one or more wellsite conditions. The downhole monitoring tools 116 may include, for example, Logging While Drilling Tools (LWD), logging tools, wire line tools, shuttle deployment type tools, deep imaging tools, deep imaging resistivity tools, optical probes mounted on the drill collar, electrical probes mounted on the drill collar, formation pressure while drilling tools (FPWD), production monitors, pressure sensors, temperature sensors, one or more receivers, and the like. The surface monitoring tools 118 may include, for example, the pressure sensor 120, the seismic truck 119 for inducing seismic waves into the earth and receivers 122 for receiving the seismic waves. Further, the receivers 122 may receive seismic waves generated by any seismic source including the drill bit, other noise sources, downhole tools, micro-seismic events, and the like. The monitoring tools 116 and 118 provided may be used to collect, send, and receive data concerning the wellsite 100 to the controller 126 and/or the containment unit 127. The data collected by the downhole monitoring tools 116 and the surface monitoring tools 118 during drilling operations may comprise data regarding the subterranean formations 130A-130G, the subterranean formation characteristics surrounding the wellbore 104 and/or the characteristics of the drilled wellbore 104. The data collected regarding the drilling operation may be sent to the well containment unit 127 in order to develop and execute the containment plan as will be described in more detail below. Once the wellbore 104 is drilled the wellbore 104 may be completed. One or more wellbores 104 may be provided. Additional rigs, such as secondary rig 136 may also be provided to reach reservoir 128.

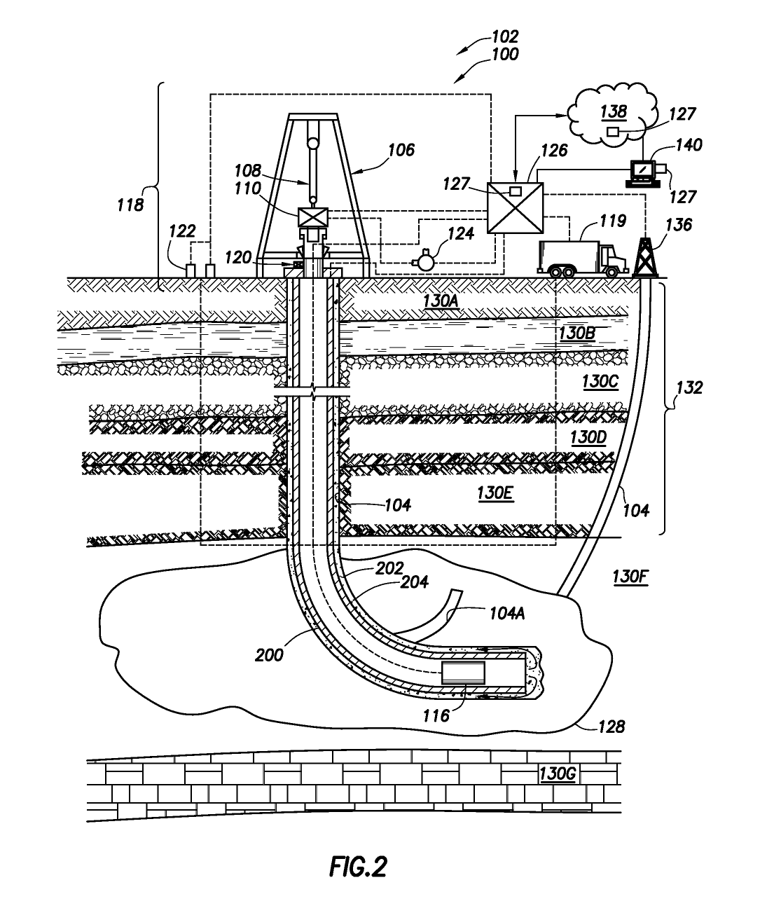

FIG. 2 depicts a schematic view of a completion operation on the wellbore 104. During the completions operation downhole equipment may be secured into the wellbore 104 for isolation and production of the wellbore 104. The downhole equipment may comprise a casing 200, a cement 202, and one or more seal assemblies, perforating guns, production tubing, downhole pumps, valves and the like (not shown). Although the wellbore 104 is shown as being completed with the casing 200, any suitable pipe or tubular may be used, including drill pipe, liners, production tubing and the like. The pumping system 124 may pump the cement 202 into an annulus 204 between the casing 200 and the wellbore 104 wall. The cement 204 may seal and/or hydraulically isolate the wellbore 104 and/or the casing 200 from fluids within the subterranean formations 130A-G. After the casing 200 is secured in the wellbore 104, one or more perforation operations may be performed in the reservoir 128 in order to fluidly couple the reservoir 128 with the casing 200 and/or production tubing (not shown) within the casing 200. The wellbore 104 may then be produced in order to retrieve the valuable downhole fluids from reservoir 128 to the surface.

The downhole equipment, and/or installed downhole equipment may comprise any equipment for use and/or installation into the subsurface system such as, but not limited to, cement, packers, seals, seal components, casing, tubing, sensors, valves, perforating guns, downhole pumps, completion equipment and the like.

During the completions operation data may be collected regarding the wellsite 100, such as the subterranean formations 130A-130G, the wellbore 104, and/or the downhole equipment. The downhole monitoring tools 116 and/or the surface monitoring tools 118 may be used to collect data regarding the wellsite 100. Further, data may be collected regarding the type of downhole equipment used. For example, data regarding the type of casing 200 (and/or downhole pipes) installed, the type of cement used, the density of the cement 202 around the annulus 204, the type of drilling mud used, the type of stimulation treatments used and the like may be collected. The data collected regarding the subterranean formations 130 (A-G), the wellbore (104), and/or the wellsite equipment may be sent to the containment unit 127 in order to develop and execute the containment plan as will be described in more detail below.

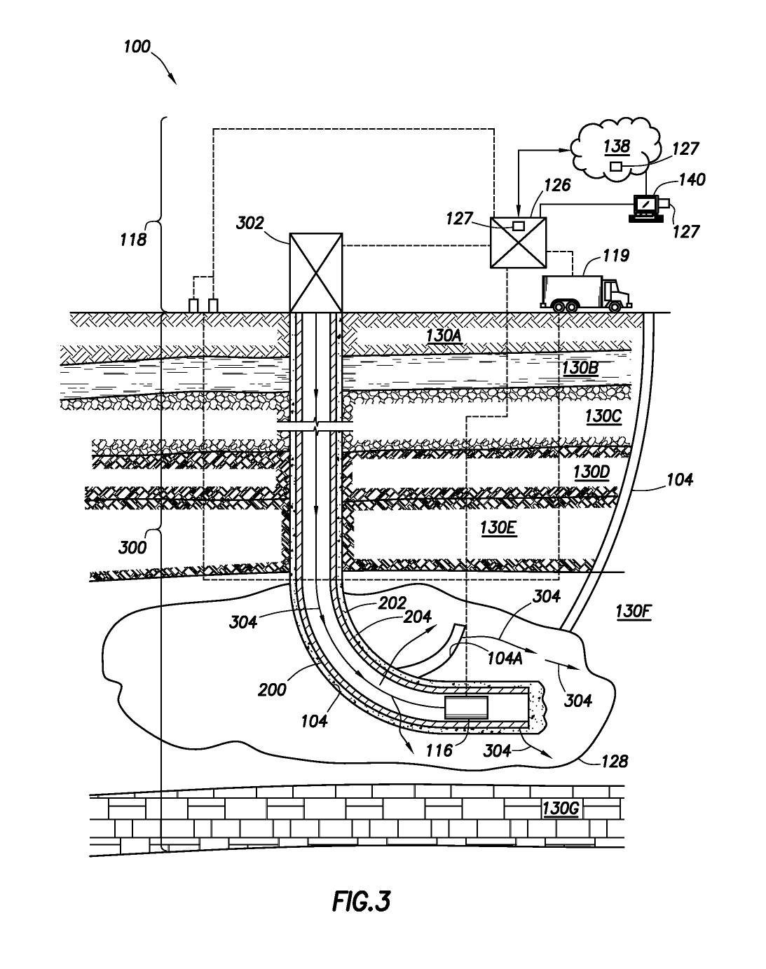

FIG. 3 depicts a schematic view of an injection operation being performed on the wellbore 104. During the life of the wellbore 104, and/or after production of the wellbore 104 fluids may be injected into a subsurface system 300 using an injection system 302. The subsurface system 300 may comprise any of the wellbore 104, the reservoir 128 and/or any of the subterranean formations 130A-G. The fluids injected into the wellbore 104 may be for stimulation, production, sealing, and/or storage about the wellsite 100.

The pumping system 124 (as shown in FIGS. 1 and 2) and/or the injection system 300 may be used to inject the fluids into the subsurface system 300. As shown in FIG. 3, a storage fluid 304 (depicted as arrows) is injected into the wellbore 104 and thereby the reservoir 128 (preferably after the reservoir 128 has been substantially drained of the valuable downhole fluids). The storage fluid 304 may be any suitable fluid that can be stored in the reservoir 128 and/or the subsurface system 300 for example, carbon dioxide (CO2), water, acid gas and the like (“injected fluids”). These injected fluids may be injected into the subsurface system 300 in an effort to reduce the number of greenhouse gases released into the atmosphere.

The injection system 302 may be any suitable system for injecting the fluid into the subsurface system 300. The injection system 302 may be in direct communication with the controller 126. Any of the monitoring tools 116 and/or 118 may be used to collect data regarding the injected fluid conditions. For example, the monitoring tools 116 and/or 118 may monitor injection pressure, rate of fluid flow, volume of fluid injected and the like. Further, the downhole monitoring tools 116 may be used prior to, during and/or after the injection operation in order to collect data regarding the injected fluid, the subsurface system 300, and/or the condition of the downhole equipment. The data collected regarding the injection operation, the subsurface system 300 and/or the injected fluid may be sent to the containment unit 127 in order to develop and execute the containment plan as will be described in more detail below.

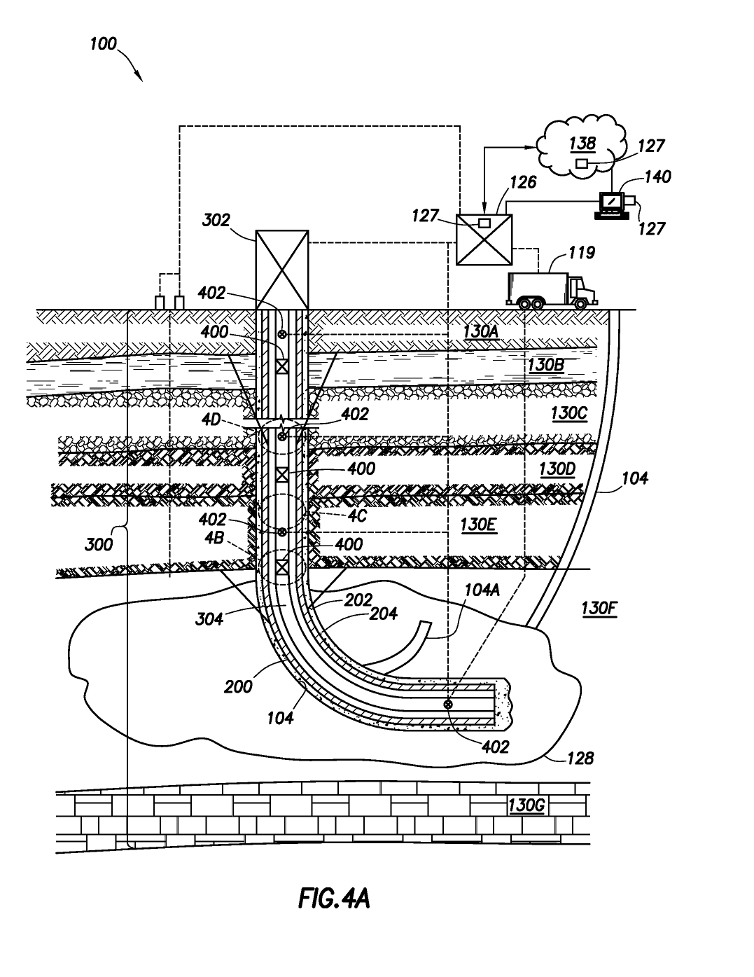

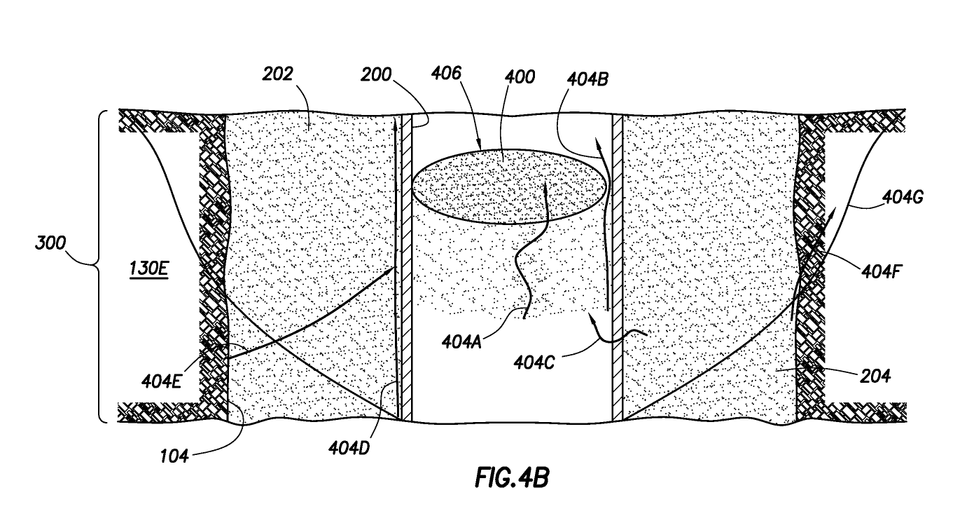

FIG. 4A depicts a schematic view of a sealing operation being performed on the wellbore 104. After the fluid, and/or storage fluid 304 is injected into the subsurface system 300 one or more seals 400 may be placed into the wellbore 104 in order to seal the injected fluids and/or subterranean fluids in the wellbore 104. The seals 400 may be any suitable seal for containing fluids in the subsurface system 300 for example, one or more cement plugs, one or more packers, the cement 202, swelling elastomers, and the like. During the seal operations the monitoring tools 116 and/or 118 may be used to determine properties of the subsurface system, the downhole equipment and the like. The downhole monitoring tools 116 may include any number of downhole sensors 402. The downhole sensors 402 may monitor fluid conditions in the sealed wellbore 104, such as pressure, the temperature, types of fluids present, and the like. The data collected regarding the sealing operation, the subsurface system 300, the fluid conditions and/or the injected fluid may be sent to the containment unit 127 in order to develop and execute the containment plan as will be described in more detail below. When the sealing operation is complete, the subsurface fluids, such as formation fluids, injected fluids and/or the storage fluids 302 will ideally be sealed within the subsurface system 300.

Prior to, during and/or after the sealing operations are performed one or more leaks 404A-G, as shown in FIG. 4B, may develop in the subsurface system 300. FIGS. 4B-4E depict schematic views of portions 4B and 4D of the wellbore 104 having a number of leaks 404A-I. FIG. 4B schematically depicts the portion 4B of the wellbore 104 of 4A. The wellbore 104 portion may have a cement plug 406 secured within the casing 200. The potential leaks that may develop in the wellbore 104 may comprise, but are not limited to, a leak 404A through the cement plug 406, a leak 404B between the casing 200 and the cement plug 406, a leak 404C through the casing 200, a leak 404D between the cement 202 in the annulus and the outer surface of the casing 200, a leak 404E through the cement 202 in the annulus 204, a leak 404F from the cement 202 in the annulus 204 to the subterranean formation 130. Further leak matrixes 404G may develop in the subsurface system 300 as the number of leaks 404A-G increase in the subsurface system 300.

FIGS. 4C-E schematically depicts a portion 4D of the wellbore 104 of FIG. 4A. FIG. 4C depicts an example of a leak 404H formed from radial cracks in the cement 202 in the annulus 204 of the wellbore 104. The radial cracks may allow fluid from within the casing 200 to flow into the subterranean formation 130 and/or allow fluid from the subterranean formation 130 into the casing 200. FIGS. 4D and 4E depict an example a leak 404I formed from disc cracking in the cement 202 in the annulus 204. When the cement 202 forms disc cracks, the leak path 404I may be substantially radial from the casing 200 to the subterranean formation 130. The disc cracks may allow fluid from within the casing 200 to flow into the subterranean formation 130 and/or allow fluid from the subterranean formation 130 into the casing 200. As the leaks 404A-I develop in the subsurface system 300, fluid flow and fluid reaction with the leaks 404A-I may increase the system of leaks and volume of fluids flowing from the wellbore 104.

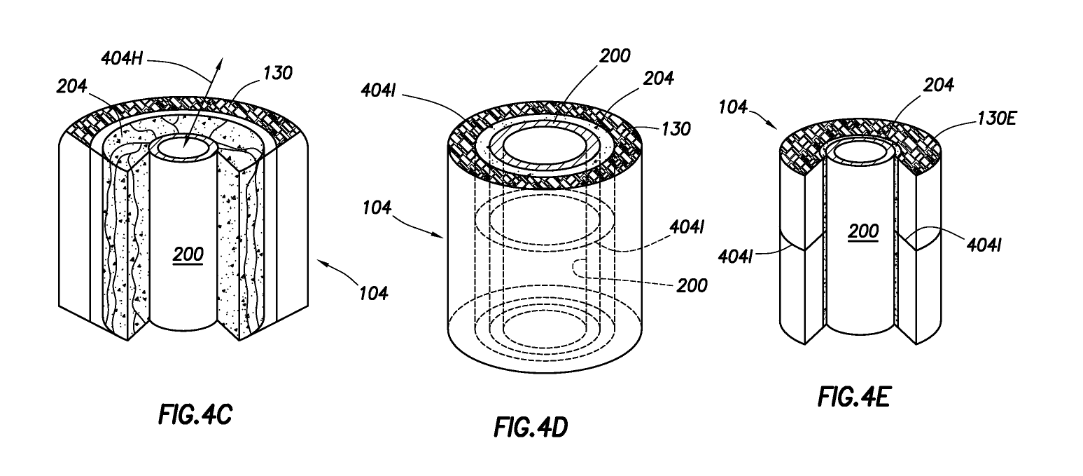

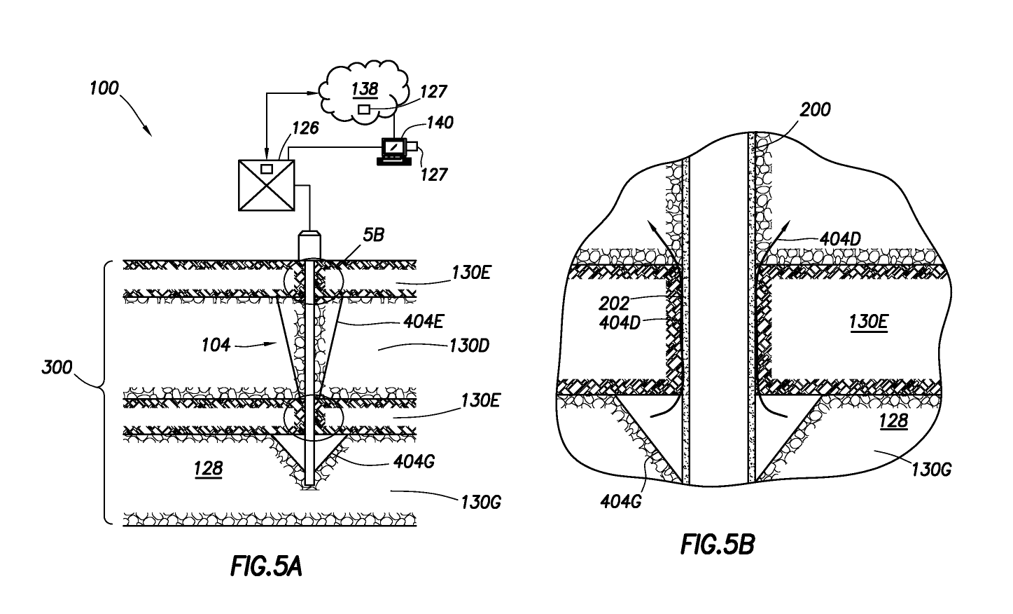

FIGS. 5A and 5B depict an alternate schematic view of the wellbore 104 of FIG. 4A having a leak pattern within the subsurface system 300. The wellbore 104, as shown in FIG. 5A has the reservoir 128, a cap rock (or sealing formation) located above the reservoir 128. Above the cap rock there may be a permeable subterranean formation 130D (or intermediate permeable formation). Above the permeable subterranean formation 130D there may be any number of subterranean formations such as another cap rock (or sealing formation). As the leaks 404A-404I (as shown in FIGS. 4B-4E) develop in the subsurface system 300, the volume of the leaks may develop into the leak matrixes 404G as shown in the reservoir 128 and the permeable subterranean formation 130D as shown in FIG. 5A. The leak matrixes 404G may allow large volumes of the fluids to flow within the subsurface system 300.

FIG. 5B is a detailed view of a portion 5B of FIG. 5A. As shown in FIG. 5B when the leak matrixes 404G reach the cap rocks the flowing fluid may migrate through the cap rock via any one of the leaks described herein. As shown, the leak 404D between the cement 202 and the casing 200 may allow the flowing fluid to travel to another of the subterranean formations, such as the permeable subterranean formation 130D. In the permeable subterranean formation 130D the flowing fluids may continue to travel along the leak matrixes 404G until the next subterranean formation 130E is reached. The flowing fluid may then flow in a similar manner as shown in FIG. 5B to escape the subsurface system 300.

As the fluids flow through the leaks 404A-I (as shown in FIG. 4B-E), the fluids may react with the subterranean formation 130, the cement 202, the casing 200 and/or seals 400 (as shown in FIG. 4A). The reaction of the fluids with the cement 202, the casing 200 and/or the seals 400 may degrade the sealing capacities of the subsurface system 300. The reaction may be created by chemical reactions and/or through erosion. The fluids may react chemically for example in the case of casing corrosion from exposure to hydrogen sulfide H2S, or cement leaching created by the CO2. The reaction of the fluids with the subsurface system 300 may increase the volume and types of leaks 404A-I as the life of the wellbore 104 continues. The containment unit 127 may be used to predict, determine and mitigate the leaks 404A-I within the subsurface system 300. Defects in the subsurface system 300, may not all necessarily develop into leaks. Defects that create a flow path may eventually become leaks, or leak matrixes, and may later develop into potential leaks, and/or probable leaks. The defects, the leaks, the leak matrixes, the potential leaks, and/or the probable leaks may all be categorized as subsurface system failures. The effect of each independent defect, leak, and/or leak matrix may be related to each possible leak path.

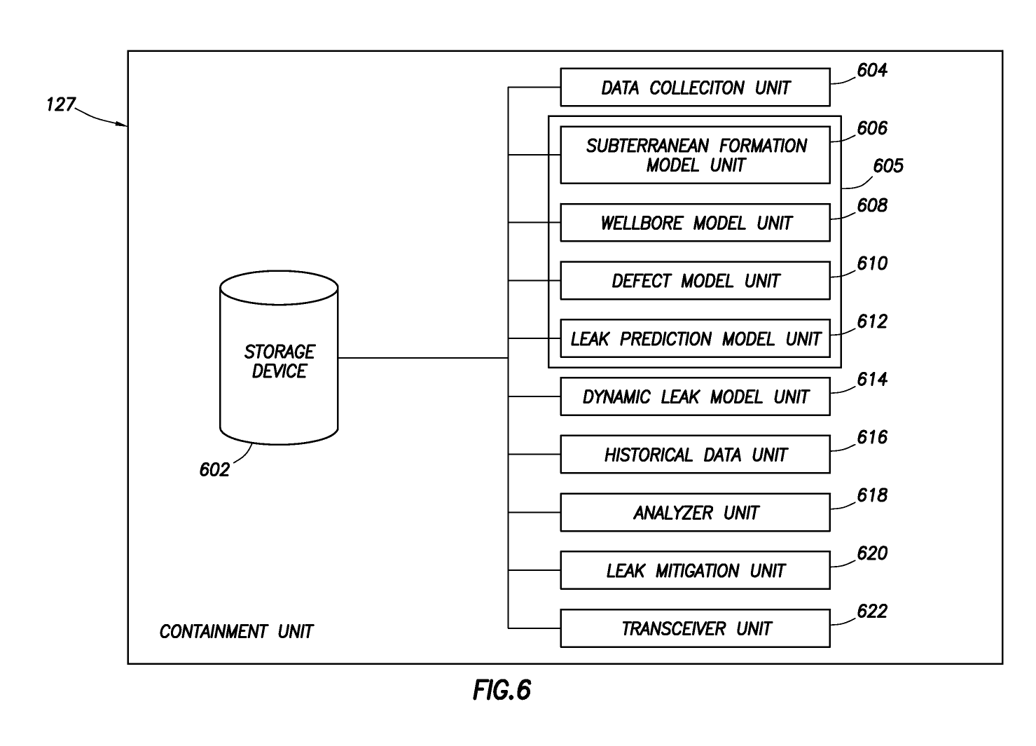

FIG. 6 is a block diagram illustrating the containment unit (sometimes referred to as a “well leak unit”) 127. The containment unit 127 may be incorporated into or about the wellsite (on or off site) for operation in conjunction with the controller 126 as shown, for example, in FIGS. 1-4A. The containment unit 127 may create a static model of the wellsite, a dynamic model of the wellsite, a real time and/or history matched model, and develop and/or execute the containment plan (sometimes referred to as a “leak mitigation plan”. The containment unit 127 may include a storage device 602, a data input unit 604, a static model unit 605, a subterranean formation unit 606, a wellbore model unit 608, a defect model unit 610, a leak prediction unit 612, a dynamic leak model unit 614, a historical data unit 616, an analyzer unit 618, a leak mitigation unit 620 and a transceiver unit 622.

The storage device 602 may be any conventional database or other storage device capable of storing data associated with the system 102, shown in FIG. 1. Such data may include, for example, wellbore data, downhole equipment data, fluid data, subterranean formation data, reservoir data, pressure data, temperature data, subsurface system failure data and the like. The analyzer unit 618 may be any conventional device, or system, for performing calculations, derivations, predictions, analysis, and interpolation, such as those described herein. The transceiver unit 622 may be any conventional communication device capable of passing signals (e.g., power, communication) to and from the containment unit 127. The data input unit 604, the static model unit 605, the subterranean formation unit 606, the wellbore model unit 608, the defect model unit 610, the leak prediction unit 612, the dynamic leak model unit 614, the historical data unit 616, the analyzer unit 618, the leak mitigation unit 620 may be used to receive, collect and catalog data and/or to generate outputs as will be described further below.

The containment unit 127 may take the form of an entirely hardware embodiment, an entirely software embodiment (including firmware, resident software, micro-code, etc.) or an embodiment combining software and hardware aspects. Embodiments may take the form of a computer program embodied in any medium having computer usable program code embodied in the medium. The embodiments may be provided as a computer program product, or software, that may include a machine-readable medium having stored thereon instructions, which may be used to program a computer system (or other electronic device(s)) to perform a process. A machine readable medium includes any mechanism for storing or transmitting information in a form (such as, software, processing application) readable by a machine (such as a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. Embodiments may further be embodied in an electrical, optical, acoustical or other form of propagated signal (e.g., carrier waves, infrared signals, digital signals, etc.), or wireline, wireless, or other communications medium. Further, it should be appreciated that the embodiments may take the form of hand calculations, operator comparisons, and/or operator execution. To this end, the operator and/or engineer(s) may receive, manipulate, catalog and store the data from the system 102 in order to perform tasks depicted in the containment unit 127.

The data collection unit 604 may collect, catalog, categorize and store any data related to the wellsite 100 (as shown in FIGS. 1-4A, and 5A). The data may comprise data relating to fluid properties, fluid movement, cement evaluation, acoustic (or noise) logs, thermal logs, pressure logs, the geology of the reservoir, the geology of the overburden, reservoir characteristics, overburden characteristics, cement design, cement placement, installed cement density, completions design, reservoir flow models, wellbore/downhole equipment, geo-mechanical state of the wellbore, geology, and any of the data described herein. The data collected in the data collection unit 604 may be communicated to, used by, and/or manipulated by the containment unit 127 in developing and/or executing the containment plan.

The static model unit 605 of the containment unit 127 may construct a static model of the wellsite 100 (as shown in FIGS. 1-4A and 5A). The static model may comprise any combination of a subterranean formation model, a wellbore model, a defect model and/or a leak prediction model. The subterranean formation unit 606, the wellbore model unit 608, the defect model unit 610, and/or the leak prediction unit 612 may develop the static model.

The subterranean formation unit 606 may receive data from the data collection unit 604 to generate the subterranean formation model. The subterranean formation model may model the characteristics of the reservoir 128, and/or the subterranean formations 130A-G (as shown in FIGS. 1-4A and 5A). The subterranean formation model may characterize the characteristics of the reservoir 128, and/or the subterranean formations 130A-G such as the density of the formations, the permeability in both single and multiple porosity systems, the porosity, porosity distribution, compressibility, the geometrical characteristics, the mechanical properties, the elastic properties, the pressure, the temperature, borehole seismic data, 3D seismic data, 4D seismic data, inversion generating rock and fluid property volumes, technology constraints, hydrocarbon potential from basin modeling studies, outcrops, rate of penetration (ROP), properties that may influence the life of the well (such as sanding and strain rate), overburden and reservoir structural models, reservoir rock petro-physical properties, rock/fluid interaction, capillary pressure curves, relative permeability curves, geo-mechanic properties, rock strength, fracturing, formation pressure, dependence of properties on pressure and temperature, fines migration, onset of sanding, fluid contact, sedimentary and structural geology, position and nature of the reservoir thickness and lateral extent, reservoir fluid properties such as types of fluid phases that may occur in the simulation model (oil, water, gas, solids such as asphaltenes and sand) and the respective saturations, densities, viscosities, compressibility, expected phase behavior, reaction between injected and formation rock and formation fluids, formation fluid spatial distributions and the like.

With the subterranean formation 130A-G and/or reservoir 128 data from the data input unit 604, the subterranean formation model unit 606 may construct the static model of the subterranean formations 130 and the reservoir 128 both near the wellbore 104 and at the wellsite 100. Generating the subterranean formation model may involve any number of modeling techniques including, analog techniques, process modeling, and multipoint statistics. The base subterranean formation model may be constructed by combining the 3D finite element property grids to generate new property models. Further, the base subterranean formation model may model the mechanical and petro physical properties of the subterranean formations 130 near the wellbore 104 (such as permeable formations, 1D Mechanical Earth Model) of the subterranean formations 130 and/or the reservoir overburden simulation properties. The models generated herein may involve the use of one or more modeling techniques, such as those described in U.S. patent application Ser. No. 12/356,137 and U.S. Patent Publication No. 2008/0300793.

The wellbore model unit 608 may receive data from the data collection unit 604 to generate the wellbore model. The wellbore model may model the characteristics of the wellbore 104, and/or the wellbore interaction with the subterranean formations 130A-G and/or the reservoir 128 (as shown in FIGS. 1-4A and 5A). The wellbore model may characterize the characteristics of the wellbore such as material used for the downhole equipment, casing materials, well materials, casing connection type, geometry of the wellbore, type of cement used in the well, type of steel and/or metal used in the well, the type of seals used in the well, type of elastomers used in the well, subterranean formation type at different elevations in the wellbore, and interfaces between the subterranean formation type and the wellbore (for example density, permeability, geometrical characteristics, mechanical/elastic properties), and the like.

With the wellbore data from the data collection unit 604, the wellbore model unit 608 may construct the static model of the wellbore 104 and the interfaces between the wellbore 104 and the subterranean formations 130 (as shown in FIGS. 1-4A and 5A). Generating the wellbore model may involve any number of modeling techniques including, analog techniques, process modeling, and multipoint statistics. The wellbore model may be constructed by combining the 3D finite element property grids to generate new property models. The models generated herein may involve the use of one or more modeling techniques, such as the ones described herein.

The defect model unit 610 may receive data from the data collection unit 604 to generate the static defect model. Further, the defect model unit 610 may receive data, and/or the constructed wellbore model, the subterranean formation model and/or portions thereof from the subterranean formation model unit 606 and the wellbore model unit 608 to generate the static defect model. The static defect model may model the characteristics of subsurface system failures in the wellbore 104, the subterranean formations 130A-G and/or the reservoir 128 (as shown in FIGS. 1-4A and 5A). The subsurface system failures may comprise the defects, the leaks 404A-G (as shown in FIGS. 4B-5B) detected by the monitoring tools 116, and/or 118, the geometry and properties of defects (for example cracks, delimitations, and/or channels), the defects mechanical properties (for example elasticity), static properties of the wellbore and/or the subterranean formations, occurring variations in temperature, occurring variations in fluid pressure (for example in the casing, the reservoir, the subterranean formations and/or the annulus, loading causing stress on the downhole equipment, and/or the probability of defects).

With the data from the data collection unit 604, the subterranean formation model unit 606, and/or the wellbore model unit 608, the defect model unit 610 may generate the static defect model of the subsurface system failures in the subsurface system 300 (as shown in FIG. 3). Known, or detected, subsurface system failures may be incorporated into the static defect model. When the defect connects a source with a target, the defect may lead to the formation of a leak, or leak path, which may be incorporated into the static defect model. Thus, all of the subsurface system failures in the subsurface system 300 (as shown in FIG. 3) may not result in a leak, or a flow path that has the potential to turn into a leak. Generating the static defect model may involve any number of modeling techniques such as those described herein.

The leak prediction model unit 612 may receive data from the data input unit 604 to generate a leak prediction model. Further, the leak prediction model unit 610 may receive data, and/or the defect model, the wellbore model, the subterranean formation model and/or portions thereof from the subterranean the defect model unit 610, the formation model unit 606 and the wellbore model unit 608 to generate the leak prediction model. The leak prediction model may model the characteristics of static leaks in the wellbore 104, the subterranean formations 130A-G and/or the reservoir 128 (as shown in FIGS. 1-4A and 5A). Thus the leak prediction model may generate leak occurrence and sizes in the subsurface system from the data input into the leak prediction model unit 612. Further, from the defect data the leak prediction model 612 unit may determine, or predict, which defects, or series of defects may generate into leaks, or leak matrixes. Thus, the leak prediction unit 612 may incorporate existing leaks, defects, potential leaks, and/or probable leaks into the static leak prediction model. The static leak prediction model may use input from the history of loading (for example through pressure, temperature, and/or stress) on the subsurface system to predict defects that are not yet directly measurable. The static leak prediction model may evaluate the probability of occurrence of wellbore integrity failure(s) which may lead to a leak, and/or the formation of the leak matrixes. The static leak prediction model may further evaluate the severity of the leak(s), leak matrixes, and/or defects in the subsurface system.

The static leak prediction model may determine leakage rates from the reservoir, and/or a subterranean formation, to a given target without taking into account changes in flow and mechanical properties associated with the exposure to the leaking fluid(s) (for example casing corrosion, cement carbonation, and the like). The boundary conditions for the static leak prediction model may be taken from the reservoir simulations of the storage reservoir, or the subterranean formation model. The reservoir simulations (models) of the storage reservoir may give the static leak prediction model data such as fluid saturation, fluid pressure, fluid temperature and the like, from the measurements, and/or data collected from the subsurface system. Generating the static leak prediction model may involve any number of modeling techniques such as those described herein. With the static model developed, the containment unit 127 may then create a dynamic leak model.

The dynamic leak model may be generated by the dynamic leak model unit 614. The dynamic leak model may evaluate the evolution of the defects, the leaks, the leak matrixes, the potential leaks, and the probable leaks in the subsurface system. Further, the dynamic leak model may determine the severity and/or potential severity of each of the subsurface system failures. In determining the evolution of the subsurface system failures, the dynamic leak model may determine the evolution, or devolution of the downhole equipment, and/or subsurface system (for example the casing steel, the cement and/or the subterranean formations) as the downhole equipment reacts with the fluid in the subsurface system failures. The reaction between the fluids and the downhole equipment, and/or subsurface system may alter the mechanical properties of the subsurface system failures possibly changing the subsurface system failure's size, geometry, flow rate and the like. The leak rate of each of the subsurface system failures may be re-evaluated by the dynamic leak model with the evolution of the subsurface system. The dynamic leak model may determine CO2 leak rates into the subterranean formations, or permeable formations, and/or the atmosphere.

The dynamic leak model may re-evaluate the leak rates with a series of simplified material degradation models which may be run in parallel to predict the long-term evolution of the downhole equipment and/or the subsurface system. This may allow the dynamic leak model to quantify the amount and probability of defects becoming leaks and flowing to any targets in the leak pathway. The long term evolution of the subsurface system failures may be determined by the dynamic leak model based on a pre-computed “map” of stability in the space of parameters (boundary conditions, static defect model outputs, etc.) A criterion may be established to estimate the long time evolution of the leakage rate. The criterion may comprise an increase in leak flow, an evenness in leak flow, a decrease in leak flow and the like. Generating the static leak prediction model may involve any number of modeling techniques such as those described herein.

Occurrence and evolution of leakage pathways generated by the dynamic leak model depends in many cases on parameters and measurements affected by varying degrees of uncertainty. Often, key characteristics of pathways (such as radial crack width) may not be measured directly. Thus, the dynamic leak model may determine a probabilistic approach to leakage, where a variation in possible leak pathway properties implies a variation in leakage prediction.

The historical data unit 616 may collect data from the data collection unit 604, the subterranean formation model unit 606, the wellbore model unit 608, the defect model unit 610, the leak prediction model unit 612, and/or the dynamic leak model unit 614. The historical data unit 616 may reduce uncertainties in the static leak model and/or dynamic leak model by incorporating current and future measurements into the static and dynamic models. The measurements may be taken by any of the monitoring tools 116 and/or 118 during the evolution of the subsurface system and sent to the containment unit 127 as data. By inputting changing data into the static and dynamic models, the historical data unit 616 may improve leak prediction capabilities with historical time matching. Thus, known leak behavior over the wellbore life, or storage life, and time-lapse measurement may be used to re-compute the uncertainties of the static leak model and/or the dynamic leak model.

The leak mitigation unit 620 may develop the containment plan in order to minimize the risk of a leak at the wellsite. The leak mitigation unit 620 may receive data from the data input unit 604, the subterranean formation model unit 606, the wellbore model unit 608, the defect model unit 610, the leak prediction model unit 612, the dynamic leak model unit 614, and/or the historical data unit 616. The containment plan may determine prevention and mitigation measures to be employed at the wellsite 100 in order to minimize the risk of leaks. The containment plan may vary depending on the stage in life the wellsite 100 is at, for example, prior to drilling, completions, injection, sealing, storage, and/or abandonment. The effect of prevention and mitigation measures may be measured and stored in the containment unit 127 in order to update the uncertainties of the static model, the static leak model, and/or the dynamic leak model, thereby allowing design of well construction, improvement and repair that eliminate or minimize the risk of leaks.

The leak mitigation unit 620 may further determine and prioritize the criticality of the subsurface system failures. For example, if there is little chance of the defect becoming a leak, the defect may have a very low priority. If the leak may become a leak matrix but has little chance of escaping to the environment (atmosphere and/or aquifer), the leak may have an higher priority, but not a critical priority. If the leak may threaten an aquifer and/or the environment, the leak may have a high priority. The prioritized criticality of the subsurface system failures may be used in developing the containment plan by the containment unit 127.

The leak mitigation unit 620 may perform a risk assessment, a risk mitigation assessment and a prevention assessment of the wellsite 100 (as shown in FIG. 1) before drilling, during drilling, during completions, during injection operations, during sealing operations, during storage, and/or after abandonment of the wellsite 100. The risk assessment may be used by the leak mitigation unit 620 to determine the risk of leaks due to the failures in the subsurface system (such as the wellbore and/or the subterranean formations). The risk assessment may be performed during the well planning stage prior to commencement of drilling operations in order to minimize the risk of leaks at the wellsite 100. For example, the containment unit 127 may develop at least part of the static leak model, and/or dynamic leak model based on data known about the subterranean formations 130, and/or the type of downhole equipment to be used in the wellsite operations. With base models developed, and the potential leaks and probable leaks determined, the leak mitigation unit 620 may develop the containment plan that will minimize, and/or prevent, the leaks during the life of the wellsite 100. Based on the pre-drilling data regarding the subterranean formations 130 and/or the downhole equipment to be used, the well mitigation plan may develop several courses of action to prevent the leaks for example, changing an initial drilling trajectory to avoid downhole risk, changing the type of cement to be used in the wellbore 104, changing the type of casing 200, changing the type of metal used in the casing 200, changing the type of connections used in the casing string, changing the type of seals to be used in the wellbore, changing the injection pressure of fluids injected into the wellbore 104, recommending not injecting fluids into the wellbore, recommending not drilling the wellbore 104 and the like. The operator and/or the controller 126 may then execute, and/or put into place, the containment plan prior to, and/or during the commencement of the drilling operations.

The risk assessment may be performed by the leak mitigation unit 620 during the drilling phase in order to minimize the risk of leaks at the wellsite 100. For example, the containment unit 127 may develop, or continue to develop, at least part of the static leak model, and/or dynamic leak model based on data known about the subterranean formations 130, and/or the type of downhole equipment during drilling. During drilling the monitoring tools 116/118 may collect more data regarding the subterranean formations 130 and/or the wellbore 104. This data may be incorporated into the containment unit 127 in order to allow the history data unit 616 to update the static and/or dynamic models. With the static and/or dynamic models developed, and the potential leaks and probable leaks determined, the leak mitigation unit 620 may develop the containment plan that will minimize, and/or prevent, the leaks during the drilling and/or the life of the wellsite 100. Based on the drilling data regarding the subterranean formations 130 and/or the downhole equipment to be used, the well mitigation plan may develop several courses of action to prevent the leaks for example, changing a current and/or initial drilling trajectory to avoid downhole risk, changing the type of cement to be used in the wellbore 104, changing the type of casing 200, changing the type of metal used in the casing 200, changing the type of connections used in the casing string, changing the type of seals to be used in the wellbore, changing the injection pressure of fluids injected into the wellbore 104, recommending not injecting fluids into the wellbore, recommending abandoning the wellbore 104 prior to the completions operation and the like. The operator and/or controller 126 may then execute, and/or put into place, the containment plan prior to commencement of the drilling operations.

The risk assessment may be performed by the leak mitigation unit 620 during the completions phase in order to minimize the risk of leaks at the wellsite 100. For example, the containment unit 127 may develop, or continue to develop, at least part of the static leak model, and/or dynamic leak model based on data known about the subterranean formations 130, the type of downhole equipment being installed during completions, and the loads on the downhole equipment during completions. During the completions operation, the monitoring tools 116/118 may collect more data regarding the subterranean formations 130 and/or the completed wellbore 104. This data may be incorporated into the containment unit 127 in order to allow the history data unit 616 to update the static and/or dynamic models. With the static and/or dynamic models developed, and the potential leaks and probable leaks determined, the leak mitigation unit 620 may develop the containment plan that will minimize, and/or prevent, the leaks during the drilling and/or the life of the wellsite 100. Based on the completions data regarding the subterranean formations 130 and/or the installed downhole equipment, the well mitigation plan may develop several courses of action to prevent the leaks for example, changing the type of cement to be used in the wellbore 104 during the completions project, changing the type of cement used at varying elevations in the wellbore, changing the type of casing 200, changing the type of metal used in the casing 200, changing the type of connections used in the casing string, changing the type/material and/or connections of the casing at varying elevations in the wellbore 104, changing the type of seals to be used in the wellbore, changing the injection pressure of fluids injected into the wellbore 104, recommending not injecting fluids into the wellbore, recommending abandoning the wellbore 104 after the completions operation and the like. The operator and/or controller 126 may then execute, and/or put into place, the containment plan prior to and during the completions operations.

If there is an existing well, or during the continued development of the wellsite 100, the risk assessment may be performed by the leak mitigation unit 620 prior to and during the fluid injection phase in order to minimize the risk of leaks at the wellsite 100. For example, the containment unit 127 may develop, or continue to develop, at least part of the static leak model, and/or dynamic leak model based on data known about the subterranean formations 130, the type of downhole equipment installed during completions, and the loads on the downhole equipment from completion, and the like. Prior to and during the injection operation, the monitoring tools 116/118 may collect more data regarding the subterranean formations 130 and/or the completed wellbore 104. This data may be incorporated into the containment unit 127 in order to allow the history data unit 616 to update the static and/or dynamic models. With base static and/or dynamic models developed, and the existing defects, existing leaks, existing leak matrixes, potential leaks and probable leaks determined, the leak mitigation unit 620 may develop the containment plan that will minimize, and/or prevent, the leaks during injection and/or the life of the wellsite 100. Based on the completions data regarding the subterranean formations 130, the installed downhole equipment, and/or injection data, the well mitigation plan may develop several courses of action to prevent the leaks for example, injecting more cement in the wellbore 104, adding seals to be used in the wellbore 104, changing the injection pressure of fluids injected into the wellbore 104, changing the types of fluids to be injected into the wellbore 104, recommending not injecting fluids into the wellbore, recommending abandoning the wellbore 104 and the like. The operator and/or controller 126 may then execute, and/or put into place, the containment plan prior to and during the injection operations.

The leak mitigation unit 620 may perform risk assessments on existing wellsite 100 to assess the risk of leak due to wellbore integrity failure. The leak mitigation unit 620 may mitigate leaks in an existing wellsite 100 to analyze the origin of a detected defect and/or leak in order to improve the injection/production condition and/or repair the leak. The leak mitigation unit 620 may prevent leaks by designing a wellsite construction and/or optimizing production/injection conditions in order to minimize the risk of well integrity failure.

Because the static and dynamic models may be developed prior to the injection operation, every parameter in the wellbore may be easily updated as new data is discovered, by the containment unit 127. This may speed up the results of the leak mitigation unit 620 thereby allowing the operator and/or controller 126 to execute the containment plan in real time during wellsite operations. The leaks that develop during the injection operation may be updated in the existing static and/or dynamic models based on the physics of degradation of material parameters.

The containment unit 127 may use any combination of modeling techniques and/or mathematical techniques to develop the containment plan. The following are a list of a few equations that may be used by the containment unit 127.

The annulus may have an annulus width (w). The width of the defect(s) vary with the pressure in the defect (Pₘₐ), and the pressure in the casing (P_{c}). The cement formation surrounding the casing may have mechanical properties represented by the coefficients H and M. The annulus may have the annulus width (w) as follows:

$$w = 1 / M ( {p}_{ma} - {Hp}_{c} ) \qquad ( Equation 1 )$$

Chemistry of the cement sheath: Front tracking model. When attacked by a flow of CO₂, the cement may evolve in a layer structure (experimental evidence). The model states that the evolution of the width of these layers of degraded d cement Lⱼ depend on the width itself, the diffusion coefficient in the cement Dⱼ, the aqueous concentrations of calcium and CO₂ in the leaking fluids c^{aq} and the calcium concentration in the cement c^{sol}. Qᵢ is the rate of component i that is release by reaction between the cement and the leaking fluid.

$$\begin{matrix}\frac{d {L}_{j}}{d t} = f ( {L}_{j} , {D}_{j} , {c}_{i}^{aq} , {c}_{i}^{sol} ) & ( Equation 2 ) \\ {Q}_{i} = g ( {L}_{j} , {D}_{j} , {c}_{i}^{aq} ) & ( Equation 3 )\end{matrix}$$

The following equations may define the evolution of the physical and chemical characteristics of the flow in the defect.

Annular flow (isothermal, T=f(z)=cst) (Equation 4)

Pressure: Mass Conservation

$$\begin{matrix}\frac{\partial ρ}{\partial t} = - \vec{∇} \cdot ( ρ \vec{V} ) and & ( Equation 5 ) \\ \vec{V} = - \frac{{w}^{2}}{μ} \vec{∇} {P}_{ma} & ( Equation 6 )\end{matrix}$$

Where:

ρ=density.

V=velocity of the fluid.

w=width of the defect.

μ=viscosity of the fluid leaking

Composition: Species Conservation

$$\frac{\partial ρ {Z}_{i}}{\partial t} = - \vec{∇} \cdot ( ρ {X}_{i} \vec{V} - ρ De \vec{∇} {X}_{i} ) + {Q}_{i} \qquad ( Equation 7 )$$

Where:

Zᵢ=total mol fraction in the component i.

Xᵢ=mol fraction of the component i in the fluid leaking

The containment unit 127 may further be used in wellsites having multiple wellbores 104 (as shown in FIG. 1. The static models and the dynamic models in each of the wellbores 104 may be run independently, preferably in parallel. Thus, as leaks develop in one of the wellbores 104, they may affect defects, and/or leaks in the other wellbores 104. The potential leaks and/or probable leaks in the other wellbores 104 may be input into the containment unit 127 by the historical data unit 616 as they develop in order to modify the static and dynamic models and/or the containment plan for each wellbore 104. Therefore, the dynamic flow in each of the multiple wellbores 104 in a field can be run independently, in parallel (e.g. for small leaks that don't affect reservoir behavior), or coupled in a single reservoir-leakage model.

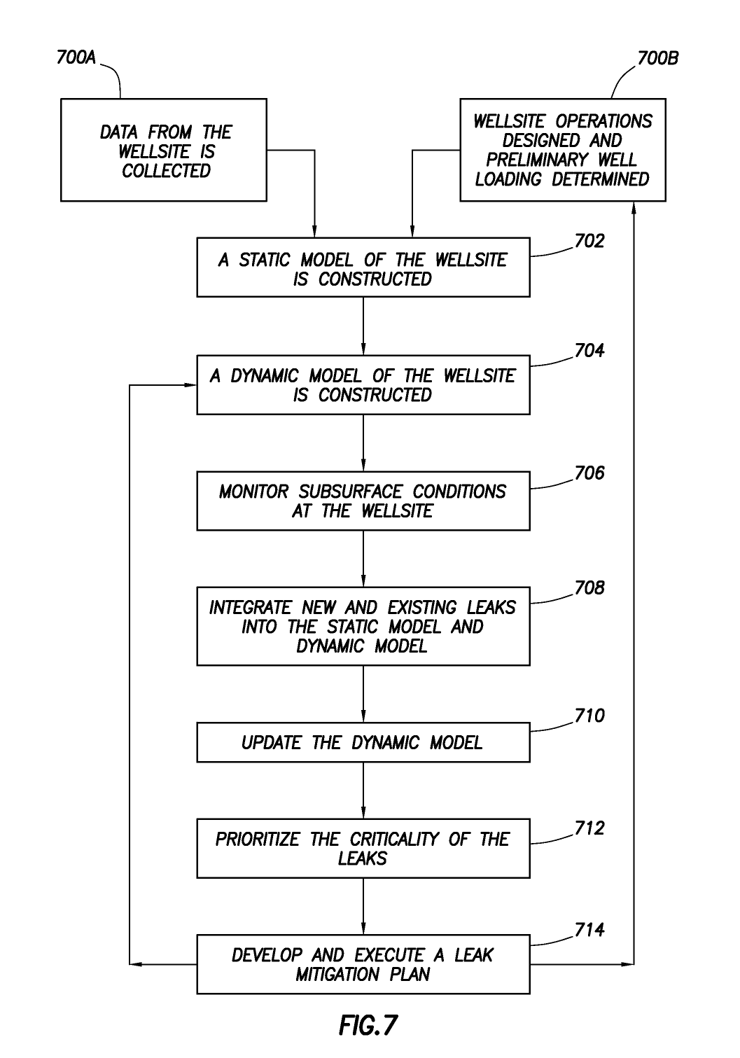

FIG. 7 depicts a flowchart illustrating the execution of a containment plan of an existing and/or potential wellsite. The containment plan may be developed as described above by the well leak unit 127 and executed by the operator and/or the controller 126 (as shown in FIG. 1). The flow begins at block 700A wherein data is collected from a wellsite. The data may be collected using any suitable techniques some of which are described herein. The data may be collected on an existing wellsite or a potential wellsite. If the wellsite is a potential wellsite the flow may further comprise block 700B wherein wellsite operations may be designed and preliminary well loading may be determined. After data collection and/or wellsite operations design, the flow continues at block 702 wherein a static model of the wellsite is constructed. The static model may comprise the subterranean formation model, the wellbore model, the defect model and/or the leak prediction model generated by the containment unit 127 and described herein. The flow continues at block 704 wherein the dynamic leak model is constructed. The flow continues at block 706 wherein one or more conditions of the wellsite are monitored in an existing wellsite, or wellsite being constructed. If the wellsite is a new wellsite being designed block 706 may be skipped until the wellsite is at least partially constructed. The flow continues at block 708 wherein leaks from the static and dynamic models may be integrated together to form leak distributions in the static model and/or the dynamic model. The flow may continue at block 710, wherein the dynamic model is updated based on the new data collected and/or the integrated leak distribution. The dynamic model update may be performed at one time, or throughout wellsite operations. The flow may continue at block 712, wherein the criticality of the subsurface system failures, and/or leaks is prioritized. If the wellsite is a new wellsite being designed block 712 may be skipped until the wellsite is under construction. The flow continues at block 714 wherein the containment plan is developed and executed. The containment plan may be developed and/or executed using any suitable techniques such as those described herein. If the wellsite is an existing wellsite, or a wellsite under construction, the changes created by the execute containment plan may be input back into the dynamic model as shown in block 704. The process may then be repeated until there is no, or little risk of the wellsite leaking. If the wellsite is a new wellsite being designed, the developed containment plan may be used as input into the design of the wellsite as shown at block 700B. If there are multiple wellsites producing in one reservoir, the data collection block 700A, the construction of the static model block 702, and the construction of the dynamic model 704 may be repeated for each of the wellsites.

While the embodiments are described with reference to various implementations and exploitations, it will be understood that these embodiments are illustrative and that the scope of the inventive subject matter is not limited to them. Many variations, modifications, additions and improvements are possible. For example, models may be generated across one or more wells in a field for performing the methods described.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A containment unit for performing leak mitigation operations about a wellsite, the containment unit comprising:
a transceiver operatively connected to a controller at the wellsite for communication therewith;
a static model unit for generating a static model of a subsurface system, the static model unit further comprising:
a defect model unit for generating a defect model wherein the defect model has a combination of known defects and/or probable defects of the subterranean formation and installed wellsite equipment;
a dynamic leak model unit for generating a dynamic leak model, wherein the dynamic leak model is for predicting a leak evolution of at least one known and/or probable leak; and
a leak mitigation unit for providing at least one containment plan for minimizing the at least one known and/or probable leak in the wellsite; and
wherein the leak mitigation unit and the dynamic leak model unit are integrated for passing data therebetween and whereby the containment plan may be adapted as the static model, the defect model, and/or the dynamic model is generated.

2. The containment unit of claim 1, wherein the static model unit further comprises a subterranean formation unit for generating a subterranean formation model that characterizes at least one property of at least one subterranean formation.

3. The containment unit of claim 2, wherein the static model unit further comprises a wellbore model unit for generating an installed wellbore model that characterizes at least one property of at least a portion of installed downhole equipment.

4. The containment unit of claim 3, wherein the wellbore model unit further characterizes at least one property of the wellbore and subterranean formation contact zone.

5. The containment unit of claim 1, wherein the static model unit further comprises a leak prediction model unit for generating a leak prediction model based on the defect model, wherein the leak prediction model determines the at least one probable leak in the wellsite.

6. A system performing a containment operation about a wellsite, comprising:
an injection system configured to inject fluids into the wellbore for storage within a subterranean formation;
at least one seal configured to prevent the injected fluids from escaping from the wellbore;
a containment unit comprising:
a transceiver operatively connected to a controller at the wellsite for communication therewith;
a static model unit for generating a static model of a subsurface system, the static model unit further comprising:
a defect model unit for generating a defect model wherein the defect model has a combination of known defects and/or probable defects of the subterranean formation and installed wellsite equipment;
a dynamic leak model unit for generating a dynamic leak model, wherein the dynamic leak model is for predicting a leak evolution of at least one known and/or probable leak; and
a leak mitigation unit for providing at least one containment plan for minimizing the at least one known and/or probable leak in the wellsite; and
wherein the leak mitigation unit and the dynamic leak model unit are integrated for passing data therebetween and whereby the containment plan may be adapted as the static model, the defect model, and/or the dynamic model is generated; and
at least one monitoring tool for collecting data about the wellsite.

7. The system of claim 6, wherein the injected fluid are a carbon dioxide.

8. The system of claim 6, wherein the static model unit further comprises a subterranean formation unit for generating a subterranean formation model that characterizes at least one property of at least one subterranean formation.

9. The system of claim 8, wherein the static model unit further comprises a wellbore model unit for generating an installed wellbore model that characterizes at least one property at least a portion of installed downhole equipment.

10. The system of claim 9, wherein the wellbore model unit further characterizes at least one property of the wellbore and subterranean formation contact zone.

11. The system of claim 10, wherein the static model unit further comprises a leak prediction model unit for generating a leak prediction model based on the defect model, wherein the leak prediction model determines the at least one probable leak in the wellsite.

12. A method for performing a containment operation about a wellsite having a subsurface system having a wellbore formed through at least one subterranean formations wherein the subterranean formations are configured to store fluids, the method comprising:
collecting initial data from the wellsite;
providing a containment unit, comprising:
a transceiver operatively connected to a controller about the wellsite for communication therewith;
a static model unit for generating a static model of a subsurface system, the static model unit further comprising:
a defect model unit for generating a defect model wherein the defect model has a combination of known defects and/or probable defects of the subterranean formation and installed wellsite equipment;
a dynamic leak model unit for generating a dynamic leak model, wherein the dynamic leak model is for predicting a leak evolution of at least one known and/or probable leak; and
a leak mitigation unit for providing at least one containment plan for minimizing the at least one known and/or probable leak in the wellsite; and
wherein the leak mitigation unit and the dynamic leak model unit are integrated for passing data therebetween and whereby the containment plan may be adapted as the static model, the defect model, and/or the dynamic model is generated;
constructing the static model of the subsurface system;
constructing the dynamic leak model of the subsurface system; and
developing a containment plan.

13. The method of claim 12, further comprising collecting supplemental data from the wellsite during wellbore operations by monitoring subsurface conditions at the wellsite.

14. The method of claim 13, further comprising updating the dynamic model from supplemental data thereby constructing a new dynamic model.

15. The method of claim 12, further comprising integrating at least two leaks into the dynamic model and thereby creating a leak distribution system.

16. The method of claim 12, further comprising executing the containment plan.
